(19) United States
(12) Patent Application Publication
(10) Pub. No.: US 2015/0147973 A1
(43) Pub. Date: May 28, 2015

(54) ENCODING CONTEXT WITHIN SERVICES DATA

(71) Applicant: Aegis Mobility, Inc., Burnaby (CA)

(72) Inventors: Stephen J. Williams, Port Moody (CA); Peter Featherstone, Surrey (CA)

(21) Appl. No.: 14/553,830

(22) Filed: Nov. 25, 2014

Related U.S. Application Data
(60) Provisional application No. 61/909,295, filed on Nov. 26, 2013.

(51) Int. Cl. H04W 76/02; H04W 8/24; H04W 4/00

(52) U.S. Cl. CPC H04W 76/02; H04W 4/008; H04W 8/24
USPC 455/41.2

(57) ABSTRACT

Systems and methods are provided enabling context information, such as a current speed of travel, to be transmitted between a context source, such as a vehicle, and a mobile device. Illustratively, the mobile device may be configured to utilize context information to enforce context-based restrictions on the mobile device, such as to restrict non-emergency functionality of the device when travelling above a threshold speed. Specifically, embodiments of the present application enable context information to be encoded within service data, and transmitted to the mobile device without requiring an established connection (e.g., a “pairing”) between the mobile device and the context source. For example, specific context information may be encoded into a service identifier, and transmitted within a service record to the mobile device. The mobile device may then decode the context information from the service identifier to determine a context, e.g., for use in context-based policy enforcement.

### CROSS-REFERENCE TO RELATED APPLICATION

This application claims the benefit of U.S. Provisional Patent Application No. 61/909,295, entitled DISCOVERY OF TIME VARIANT PUBLIC SERVICES BASED ON CONTEXT, and filed Nov. 26, 2013, which is hereby incorporated by reference in its entirety.

### BACKGROUND

Generally described, mobile devices, such as mobile phones, facilitate audio and data communications for users. In one aspect, users can utilize a mobile device for audio and data communication without reference to the particular environment in which they are attempting to utilize the mobile device. For example, a stationary user can utilize a mobile phone in an area in which use of the phone does not necessarily pose a safety issue to the user or other individuals in the nearby area. In another aspect, however, the particular environment surrounding the user and/or use of the mobile device in the particular environment can impact the use of the mobile device, the safety of the specific users, and/or the safety of other individuals.

By way of example, driver distraction can be responsible for a large and growing number of road traffic accidents. One increasing cause of driver distraction is the operation of a mobile device while driving, such as for the purposes of audio conversation. As applied to driving (and other activities), the distraction associated with operation of a mobile device can be characterized in terms of the mechanical operation of the device (e.g., dialing numbers on a keypad to initiate a call) and/or the cognitive load of the subsequent communication session (voice communications and/or operation of the device). Additionally, the continued evolution of mobile devices into multifunctional components, such as for text messaging, image and video capture, handheld gaming, etc., will only continue to increase the potential for operator distraction and/or additional cognitive load on users during operation of the mobile device.

In some systems, sensors external to a mobile device can monitor a context of the mobile device (or mobile device environment). For example, sensors attached to or embedded within a vehicle can be used to monitor the vehicle's speed. Frequently, these sensors communicate with the mobile device via an established connection, such as a paired BLUETOOTH connection. However, mobile devices or sensors can be limited in the number of connections that they can simultaneously maintain. For example, a BLUETOOTH-enabled mobile device may only be capable of “pairing” (e.g., maintaining an established connection) with a single other device at any given time. Thus, pairing a sensor and mobile device via BLUETOOTH or other limited connection technique may inhibit the ability of the mobile device to communicate with additional devices.

### BRIEF DESCRIPTION OF THE DRAWINGS

FIG. 1 is a schematic block diagram depicting an illustrative environment in which a context assessment service may operate to provide context information within services data, without requiring an established connection to a mobile device;

FIGS. 2A-2C are flow diagrams illustrating interactions for transmitting context information to a mobile device within services data, without requiring an established connection to the mobile device, to enable enforcement of context-based policies on the mobile device; and

FIG. 3 is an illustrative routine for transmitting context information encoded within services data to a mobile device.

### DETAILED DESCRIPTION

Generally described, aspects of the present disclosure relate to the transmission of context information, such as information describing an area in which a mobile device is operating, between a context source and a mobile device, without requiring an established connection between the context source and the mobile device. Specifically, a context source, such as a context assessment service operating within a vehicle, can encode context information (e.g., the vehicle's speed, location, etc.) within service data, and transmit the service data to the mobile device. As used herein, service data can generally include data transmitted from a service-providing device, such as a BLUETOOTH headset, to a potential service-using device, such as a mobile phone, to purportedly establish services provided by the service-providing device. For example, service data can indicate that a BLUETOOTH headset provides a headset service, hands free service, advanced audio distribution profile (A2DP) service, etc. Additional examples of service data are described in more detail below. Generally, service data is used by mobile devices to determine what types of services are available from nearby devices. Accordingly, transmission of service data can occur outside of any established connections between a mobile device and a service-providing device. In accordance with embodiments of the present disclosure, a context assessment service can be configured to monitor the context of a mobile device or a mobile device's operating area, and to report the context to the mobile device within service data. For example, a context assessment service located within a vehicle may monitor a state of the vehicle to determine whether operation of mobile devices within the vehicle should be restricted. Thereafter, the context assessment service can encode context information (e.g., information indicating the vehicle is in a “driving” context) within service data. A mobile device can be configured to periodically query the context assessment service to receive service data encoded with context information. The mobile device can therefore implement restrictions on the functionality of the device based on the context. For example, an application operating on the mobile device may disable voice communication functionality on the device. Because context information is transmitted through service data and independent of an established connection, the ability of the mobile device to establish connections with alternative devices or peripherals is not impeded.

Embodiments of the present application may utilize the BLUETOOTH protocol to transmit encoded context data. For example, a context assessment service may implement an instance of a BLUETOOTH Service Discover Protocol (SDP) server. More information regarding the BLUETOOTH SDP protocol may be found within the BLUETOOTH core specification, a version of which is available at https://www.bluetooth.org/DocMan/handlers/DownloadDoc.ashx?doc_id=282159. A BLUETOOTH SDP server can generally advertise available services via a listing of service universally unique identifiers (UUIDs). In the BLUETOOTH specification, each UUID comprises a 16 octet, 128 bit number, which is frequently represented by 32 hexadecimal digits, separated into five groups (a first group of eight digits, three groups of four digits, and a final group of twelve digits). An example UUID may correspond to the 128 bit number “123e4567-e89b-12d3-a456-426655440000.” In the BLUETOOTH protocol, some common services have been assigned reserved UUIDs. These reserved UUIDS utilize a short-form UUID, representable by at most 32 bits (sometimes referred to as a uuid32), and frequently 16 bites (“uuid16”). For example, a BLUETOOTH videoconferencing service corresponds to the uuid16 “0x110F.” UUIDs with values greater than 32 bits may be allocated for a variety of purposes. As will be discussed in detail below, aspects of the present application enable use of UUIDs, such as unreserved BLUETOOTH UUIDs, to encode and transmit context information from a context source to a mobile device, without requiring that the context source and mobile device be paired prior to, during, or after transmission.

While aspects of the present disclosure may be discussed with regard to BLUETOOTH services, and UUIDs for such services, embodiments of the present disclosure may encode context information in service data corresponding to a number of service discovery protocols. Examples of such service discovery protocols include, but are not limited to, Near Field Communication (NFC) Logical Link Control Protocol (LLCP), SRV records utilized within internet protocol (IP) domain name service (DNS) lookups, IP Service Location Protocol (SLP), and the IP Zeroconf protocol (including proprietary variations of such protocols, as implemented by MICROSOFT, APPLE, LINUX, and BSD). Each of these protocols generally allows a service-providing device to encode service data regarding a set of available services, and to transmit such service data to an inquiring device.

In accordance with embodiments of the present disclosure, a context assessment service may operate to encode context data regarding a mobile device or mobile device operating area within service data, according to any of the above-discussed protocols. Illustratively, a context assessment service may include one or more components configured to provide context information to a mobile device for the purposes of enforcing context-based policies on the mobile device. Context information can generally describe the state of a mobile device or an environment in which the mobile device is operating. For example, context information can reflect that a mobile device is in a “driving” context, because the mobile device is within the driver's compartment of a moving vehicle. A corresponding context-based policy may require that specific functionalities of the mobile device, such as voice or text-message capabilities, must be disabled when in the “driving” context. Enforcement of policies on a mobile device based on context information is discussed in more detail within U.S. patent application Ser. No. 12/040,832, entitled “MANAGEMENT OF MOBILE DEVICE COMMUNICATION SESSIONS TO REDUCE USER DISTRACTION,” and filed Feb. 29, 2008 (the “'832 application”), which is hereby incorporated by reference in its entirety.

In some instances, context information may reflect data gathered from one or more sensors present within a context assessment service. For example, a context assessment service may include a set of internal sensors, such as a global positioning system (GPS) or accelerometers, enabling the context assessment service to monitor movement (e.g., with respect to acceleration, speed, velocity, current location, etc.). The context assessment service may also be in communication with external sensors, such as sensors of a vehicle in which the context assessment service resides, of telematics systems installed within such a vehicle, or of mobile devices within the vehicle. As will be described below, the context assessment service may process either or both internal or external sensor information to determine context information of a mobile device or an area in which the mobile device operates.

After determining context information of a mobile device or mobile device operations area, the context assessment service may provide the context information to the mobile device within encoded service data. In one embodiment, the context assessment service may provide encoded service data to the mobile device in response to a service query. Such a query may be transmitted periodically by the mobile device in order to locate nearby services. For example, a mobile device may transmit a service query ever n seconds in order to receive service data from service-providing devices within communication range of the mobile device. In one embodiment, the service query corresponds to a BLUETOOTH SDP request. In other embodiments, the service query corresponds to an NFC LLCP services request, an IP SRV record request, or an IP Zeroconf request.

The context assessment service may respond to service requests by encoding gathered context information within service data, and providing the service data to a mobile device. As described above, available services are often identified within service data by a UUID of the service. In accordance with embodiments of the present disclosure, both a mobile device and the context assessment service may be configured to associate specific service UUIDs to potential contexts. For example, a “driving” context may be associated with a first UUID, a “stationary” context could be associated with a second UUID, etc. In one embodiment, such associations may be pre-configured and arbitrary. In other embodiment, associations between contexts and UUIDs may follow a pre-established pattern or algorithm, as described in more detail below. Thereafter, the context assessment service can provide the encoded service data to the mobile device 102. The mobile device may decode or decrypt the context information in order to determine modifications to the behavior of the mobile device based on the context information. In one embodiment, context information encoded within service data may include an abstracted context, such as “in city driving,” “highway driving,” “stationary,” etc. Abstracted contexts can generally include a label that designates a specific context, without reliance on underlying sensor data that indicates the context. Thus, a mobile device may implement policies based on an “in city driving” context, without requiring knowledge of the sensor data (e.g., vehicle speed data) used to determine the “in city driving” context. In another embodiment, context information can include information gathered from one or more sensors, such as a speed or location of a vehicle or mobile device operating area. In either instance, a mobile device may utilize context information to implement a set of context-based policies restricting or altering functionality of the mobile device. For example, a mobile device may be configured with a set of policies that require specific functionalities of the mobile device to be disabled when the mobile device is in an “in city driving” context.

While some embodiments are discussed herein enabling encoded service data to be transmitted to a mobile device, other embodiments of the present disclosure can enable encoded service data to be transmitted to third party devices configured to limit or modify functionality of a mobile device in response to context information. For example, embodiments of the present disclosure can enable service data encoded with context information to be transmitted to a telematics system including a context-based policy enforcement service. As a further example, embodiments of the present disclosure can enable service data encoded with context information to be transmitted to a communications repeater configured to enforce context-based policies on a mobile device.

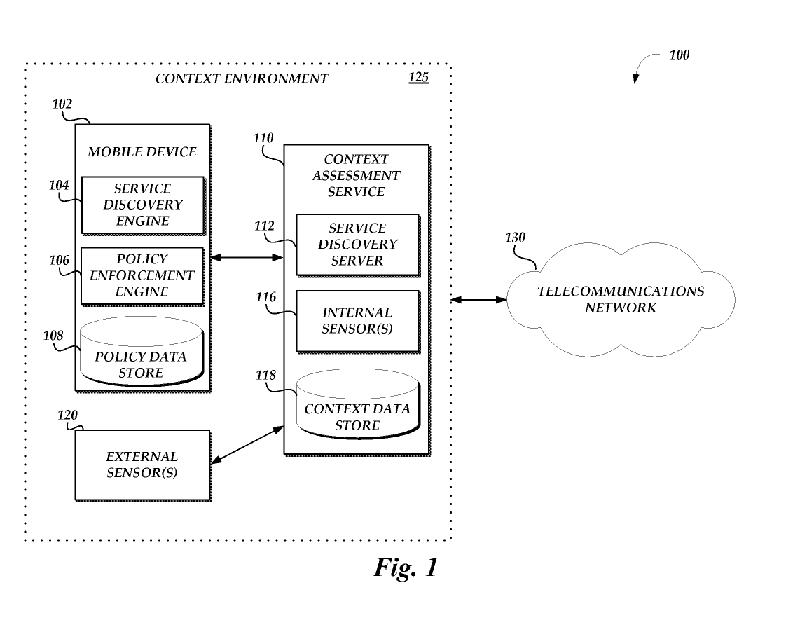

With reference to FIG. 1, an illustrative environment 100 will be described in which a context assessment service 110 can provide service data encoded with context information to a mobile device 102. As shown in FIG. 1, the illustrative embodiment of a context assessment service 110 includes a service discovery 112, an external interface 114, one or more internal sensors 116, and a context data store 118. The context assessment service 110 may operate within a context environment 125, from which context information pertaining to the mobile device 102 can be gathered. In FIG. 1, the context environment 125 may correspond to a vehicle, such as a car, boat, or airplane; a fixed location, such as a restricted-access room; or any other area in which context-based policy enforcement on mobile devices 102 is desired.

A mobile device 102 may correspond to any computing device configured to implement context-based policy enforcement, including (but not limited to) a laptop or tablet computer, personal computer, personal digital assistant (PDA), hybrid PDA/mobile phone, mobile phone, global positioning system (GPS) device, electronic book reader, car stereo system head unit, wearable computing device, camera, audiobook player, digital media player, in-flight entertainment system, integrated components for inclusion in computing devices, electronic devices for inclusion in vehicles or machinery, or the like. While illustrative embodiments are described herein with reference to a single mobile device 102, the operating environment 100 may include any number of mobile devices 102 in communication with the context assessment service 110.

The mobile device 102 may be in communication with a wide-area telecommunications network 130, such as a cellular network operated by a cellular telephone or data provider. The telecommunications network 130 may correspond to any wide-area communications network, including terrestrially-based networks, satellite networks, voice only networks (e.g., via traditional cellular telephony), data only networks, combined voice and data networks, networks created or operated by or on behalf of the public, privately operated networks, and government networks. Protocols for wirelessly communicating between a mobile device 102 and a telecommunications network 130 are well known within the art and therefore will not be described in detail herein. Such protocols may include, by way of non-limiting example, CDMA, iDEN, WiMAX, TDMA, AMPS, GSM, GPRS, UMTS, EDGE, and LTE protocols. In one embodiment, the mobile device 102 is configured to utilize the telecommunications network 130 to communicate with a third party service (not shown in FIG. 1) regarding context-based policy enforcement. For example, the mobile device 102 may interact with a third party service to download software implementing the service discovery engine 104 or the policy enforcement engine 106, or to download data stored within the policy data store 108. Each of these components of the mobile device 102 is described in more detail below.

In some embodiments, the context assessment service may also include hardware and/or software components to communicate with the telecommunications network 130. Accordingly, the context assessment service 110 may utilize the telecommunications network 130 to interact with a third party service (not shown in FIG. 1) to download data stored within the context data store 110, or software implementing the service discovery server 112, as described in more detail below. In some embodiments, either or both the mobile device 102 and the context assessment service 110 may communicate with third parties to provide context information (such as a current context of the context environment 125) or details regarding enforcement of policies on the mobile device 102.

In accordance with embodiments of the present disclosure, the context assessment service 110 may utilize a variety of internal sensors 116 and/or external sensors 120 to determine context information of the mobile device, and to make such context information available through encoded service data. Internal sensors 116 may generally include any components of the context assessment service 110 whose state indicates a physical state of the context assessment service 110, a mobile device 102, the area in which the context assessment service 110 operates, or a combination thereof. For example, internal sensors 106 may include a GPS device or accelerometer associated with the context assessment service 110. While the moniker “internal” is used for simplicity to distinguish from external sensors 104, and sensor directly associated with the context assessment service 110, as opposed to a secondary device, may be considered an internal sensor for the purposes of the present disclosure, regardless of whether such as sensor is physically located within context assessment service 110.

In some embodiments, internal sensors 116 may include one or more antennae of the context assessment service 110. For example, the context assessment service 110 may utilize an apparent signal strength between mobile device 102 and one or more antennae of the context assessment service 110 to determine information regarding the mobile device 102. Illustratively, the context assessment service 110 may include several antennae arranged at various locations within the context environment 125. Accordingly, the context assessment service 110 may utilize the apparent signal strength of a mobile device 102 at multiple antenna to determine (e.g., via triangulation) an estimated location of the mobile device 102 within the context environment 125. Where the context environment 125 corresponds to a car, a first antenna may be placed in the vicinity of a driver's seat, and a second antenna may be placed in the vicinity of a passenger seat. The context assessment service 110 may inspect the relative signal strength of a mobile device 102 between the first and second antenna to determine whether the mobile device 102 is operated by a driver or a passenger. In some instances, shaped or directional antenna can be utilized to increase the disparity in signal strength between various antennas. Still further, the context assessment service 110 may utilize communications latency between antennae, either alone or in conjunction with signal strength, to determine location of a mobile device 102. For example, a mobile device 102 that experiences less latency when transmitting to a driver's seat antenna can be expected to reside within the driver's seat.

External sensors 104 may include any sensor associated with a secondary device, such as a vehicle in which the context assessment service 110 is installed. For example, external sensors 104 may include sensors located within a vehicle in which the context assessment service 110 is installed. Illustratively, external sensors 104 may include speedometers, gearshift status sensors, accelerometers, weight detectors (e.g., within the driver's or passenger's seats), wireless communication devices, navigation devices, or stereo devices of a vehicle. Examples of information received from such external sensors 104 include, but are not limited to, vehicle speed or acceleration, currently selected gear, whether wireless communication functions (e.g., vehicle-based BLUETOOTH communications), navigation systems, or stereo systems are in use, and detailed information regarding such use (e.g., number dialed, destination, stereo volume, etc.). In one embodiment, the context assessment service 110 may retrieve sensor information from the external sensors 120 via an onboard diagnostics port (e.g., an OBD, OBD-II or J-Bus port). In another embodiment, the context assessment service 110 may retrieve sensor information from the external sensors 120 via a wireless (e.g., BLUETOOTH) or hard-wired (e.g., USB) communication link with the external sensors 120.

The context assessment service 110 can further include a context data store 118 containing information enabling assessed sensor information to be mapped to one or more contexts, and for such contexts to be encoded within service data. Illustratively, the context data store 118 may correspond to any permanent or semi-permanent data store, such as a hard disk drive (HDD), solid state disk (SSD) drive, or other persistent memory. In one embodiment, the context data store 118 includes a set of context rules utilized by the context assessment service 110 to determine a context based on sensor data. For example, a first context rule may specify that mobile devices are in a “stationary” context when the context environment 125 has remained stationary for a specified period of time. A second context rule may specify that the mobile device is in a “highway driving” context when the mobile device has been traveling over a threshold speed for a specified period of time. Each context rule may specify one or more sensor data parameters necessary or sufficient to determine a context of the mobile device. The context data store 118 can further include one or more encoding rules enabling context information (e.g., a determined context and/or sensor data establishing context) to be encoded within services data. For example, encoding rules may map a set of determined contexts (e.g., “driving” context, “stationary” context, etc.) to specific UUIDs. As a further example, encoding rules may specify an algorithm for transforming sensor data, context names, or context identifiers into UUIDs, as discussed in more detail below.

The context assessment service 110 further includes a server discovery server 112 configured to transmit context information encoded within service data to the mobile device 102. In embodiments where the mobile device 102 and context assessment service 110 communicate via BLUETOOTH, the service discovery server 112 may implement an instance of a BLUETOOTH SDP server. In embodiments where the mobile device 102 and context assessment service 110 communicate via IP protocols, the service discovery server 112 may implement, for example, an instance of an SRV record server or IP Zeroconf server. In embodiments where the mobile device 102 and context assessment service 110 communicate via NFC protocols, the service discovery server 112 may implement an instance of an NFC LLCP server. The service discovery server 112 can be configured to respond to service enquiries from the mobile device 102 with encoded service data, which reflects a context of the mobile device 102 or the context environment 125. For example, the service discovery server 112 may respond to a service enquiry by the mobile device 102 with a services list including one or more UUIDs reflective of a context of the context environment or of sensor data gathered by, for example, the internal sensors 116 or external sensors 120.

The mobile device 102 illustratively includes a service discovery engine 104 configured to transmit service enquiries to the context assessment service 110, and to retrieve and process service data including encoded context information. Illustratively, where the mobile device 102 and context assessment service 110 communicate via BLUETOOTH, the service discovery engine 104 may implement an instance of a BLUETOOTH SDP client. Where the mobile device 102 and context assessment service 110 communicate via NFC or IP protocols, the service discovery engine 104 may implement an NFC or IP service client, respectively. The service discovery engine 104 may be configured to periodically query the context assessment service 110 for a list of available services. Because service queries do not generally require an established connection between the mobile device 102 and the context assessment service 110, transmission of service queries can be expected not to disrupt other functionalities of the mobile device 102 (e.g., by allowing the mobile device 102 to pair with alternative devices).

The service discovery engine 104 is further configured to decode context information encoded within service data, to determine a current context of the mobile device 102 or the context environment 125. In one embodiment, the mobile device 102 can maintain a set of encoding rules similar or identical to those maintained by the context assessment service 110 and used to generate UUIDs. For example, the mobile device 102 can maintain a mapping of specific UUIDs to corresponding contexts, or one or more algorithms allowing a context to be derived from an encoded UUID. Encoding rules can be maintained, for example, in the data store 108, which may correspond to any permanent or semi-permanent data store, such as a hard disk drive (HDD), solid state disk (SSD) drive, or other persistent memory.

The mobile device 102 further includes a policy enforcement engine 106 configured to utilize context information retrieved from the context assessment service 110 to modify functionality of the mobile device 102. In one embodiment, the policy enforcement engine may be implemented by a software application executing on the mobile device 102. The policy enforcement engine may be configured to retrieve one or more policies from the policy data store 108, and to restrict or modify functionality of the mobile device 102 in a manner specified within the policies. Illustratively, the policy data store 108 may include any number of policies, each of which include communication criteria, context criteria, or both. Communication criteria may include a set of criteria to identify communications to which the policy should apply. Communications criteria may specify, among other parameters, a type of communication including the mobile device (e.g., voice, data, text, or combinations thereof), the content of such communications (e.g., the data being transmitted, the content of a text message, the protocol via which the communication is made or encoded, etc.), the party to whom the mobile device 102 is communicating (e.g., as identified by a destination address, such as a universal resource locator (URL) or IP address, a telephone number, a contact identifier, etc.), or the source of the communications (e.g., as originating from the mobile device 102 or an external communications network 130). For example, a policy include communication criteria specifying that the policy should apply to all outgoing voice telephone calls made by the mobile device 102, except telephone calls made to a predefined set of emergency contacts (e.g., including government established emergency numbers, user-defined emergency contacts, etc.).

A policy may further include a set of context criteria indicating a context of the mobile device 102 or context environment 125 during which the policy should be enforced. For example, the context criteria may specify that a policy should be enforced when the mobile device 102 or context environment 125 is in an “in motion” context, in a “in city driving” context, in a “highway driving” context, etc. Each context can be defined at least in part based on context information encoded within service data received from the context assessment service 110. Establishment of context based at least in part on sensor information is discussed in more detail within the '832 application, incorporated by reference above. In some embodiments, context criteria may directly specify sensor information associated with a corresponding policy. For example, context criteria may specify that a policy should be enforced on any communications from a mobile device located in a driver's area of a vehicle when the vehicle is moving at above a threshold speed (e.g., as determined via sensor data encoded within service information received at the mobile device 102).

Policies within the policy data store 108 may include one or more actions to be implemented by the policy enforcement engine 106 when actions matching specified communications and/or context criteria are detected. For example, a policy may specify that the policy enforcement engine 106 should allow or disallow communications matching one or more communication criteria and/or context criteria. As a further example, a policy may specify that the policy enforcement engine 106 should allow specific communications (e.g., based on communications and/or context criteria), but that a warning should be output to the mobile device 102 or appended to the specific communications. As yet another example, a policy may specify that the policy enforcement engine 106 should alter specific communications (e.g., by routing the communications to an alternative party), or that the policy enforcement engine 106 should create a report of specific communications and provide the report to a third party (e.g., a parent, a business that owns or operates the vehicle, etc.).

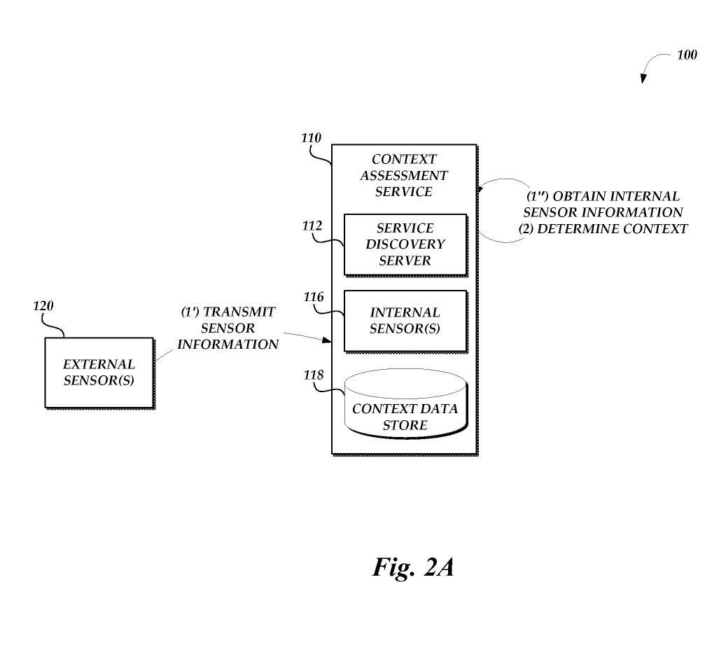

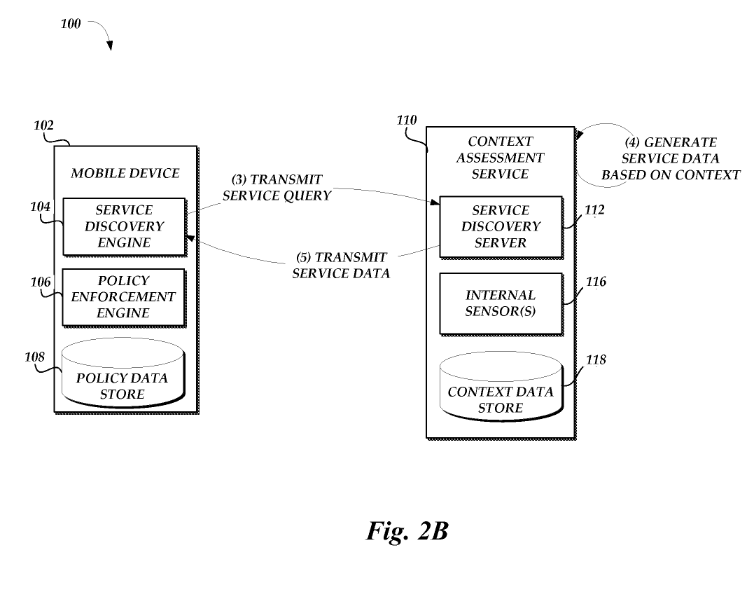

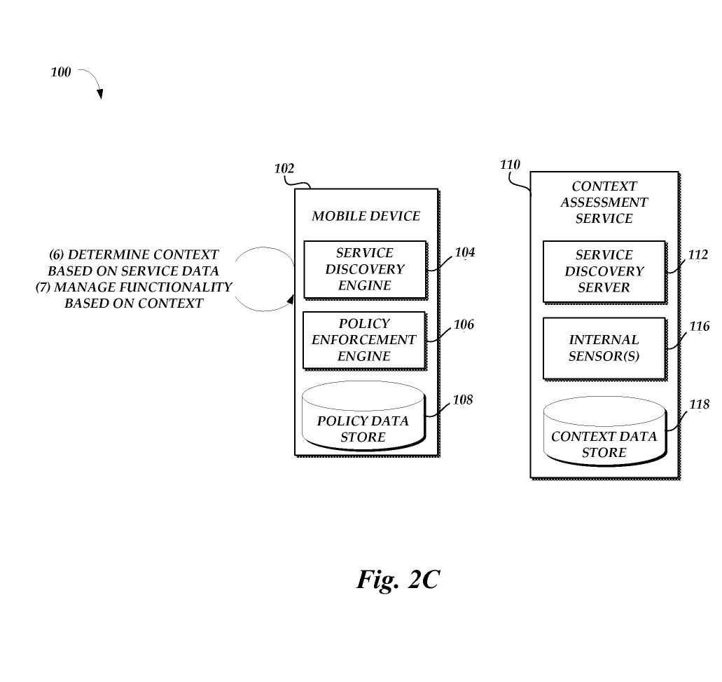

With respect to FIGS. 2A-C, illustrative interactions will be described for transmitting context information from a context assessment service 110 to a mobile device 102 via services data, independent of an established communication link between the context assessment service 110 and the mobile device 102. Specifically, FIG. 2A depicts an illustrative interaction for determining context information at the context assessment service 110 based at least in part on information from internal sensors 116 and/or external sensors 104. FIG. 2B depicts the generation of service data based on the context information, and transmission of service data in response to a service query. FIG. 2C depicts the enforcement of context-based policies a mobile device based at least in part on received context information. For simplicity, interaction number is maintained between FIGS. 2A-C. However, the interactions of each figure may occur independently from the interactions of other figures.

With reference to FIG. 2A, interactions will be described to determine context information relevant to a mobile device 102 at the context assessment service 110 based at least in part on information from internal sensors 116 and/or external sensors 104. Specifically, at (1′) and (1″), the context assessment service 110 obtains sensor data from either or both internal sensors 116 or external sensors 104. Sensor data may include any data relevant to the context of a mobile device 102 or the context environment 125. For example, sensor data may include a speed of travel of the context assessment service 110, mobile devices 102, or a vehicle in which the context assessment service 110 is installed. As a further example, sensor data may indicate whether a vehicle is in gear, a vehicle moving at a specific speed or within a specific area, or specific features of a vehicle, such as a hands-free Bluetooth connection, navigation system, or stereo system are currently in user or being interacted with by a user.

Thereafter, at (2), the context assessment service 110 may process the received sensor data to determine a current context of the context environment 125 or mobile devices 102. In one embodiment, the context assessment service 110 may utilize one or more context rules within the context data store 118 to determine current context information. For example, rules within the context data store may specify that a “driving” context exists when sensor data indicates a positive speed of a vehicle, or indicates that the vehicle is in a non-parked state. Further information regarding definition of contexts based at least in part on sensor data is described in more detail in the '832 application, incorporated by reference above.

The interactions described with respect to FIG. 2A can continue within FIG. 2B, which depicts transmission of service data to the mobile device 102 encoded with the context information described above. Specifically, the interactions of FIG. 2B begin at (3), where the mobile device 102 (e.g., utilizing a service discovery engine 104) transmits a service query to the context assessment service 110 (e.g. via the service discovery service 112). In one embodiment, the service query may be transmitted directly to the context assessment service 110. In another embodiment, the service query may be transmitted in a “broadcast” mode, without specifically targeting the context assessment service 110. Illustratively, transmission of the service query may correspond to the mobile device 102 entering into a service discovery mode. For example, transmission of the service query may utilize the BLUETOOTH SDP to transmit a service discovery request to any BLUETOOTH devices nearby to the mobile device 102. In other embodiments, transmission of the service query may utilize IP protocols (e.g., to retrieve an IP SRV record or transmit an IP Zeroconf request). Advantageously, transmission of a service query utilizing protocols described above may be accomplished without first establishing a dedicated connection between the mobile device 102 and the context assessment service 110. Thus, no “pairing” is required to transmit context information between the mobile device 102 and the context assessment service 110. Lack of pairing may be advantageous in that less interaction by an operator of the mobile device 102 is required, and that the mobile device 102 is not later prevented from establishing connections (“pairing”) with additional or alternative devices.

At (4), the context assessment service 110 generates service data utilizing the previously determined context information. Specifically, the context assessment service can generate service data encoded with information enabling the mobile device 102 to determine a current context. Illustratively, the context assessment service 110 can retrieve a set of encoding rules from the context data store 118 mapping determined context information to one or more UUIDs. In one embodiment, encoding rules may directly map determined contexts (e.g., “driving” context, “stationary” context, etc.) to specific UUIDs. Accordingly, the context assessment service 110 may generate service data (e.g., BLUETOOTH SDP data, an SRV record, NFC LLCP data, or IP Zeroconf data) including a set of UUIDs mapped to a set of determined context information. In another embodiment, encoding rules may specify an algorithm for transforming sensor data, context names, or context identifiers into UUIDs. For example, a plain-language context name (or other context identifier) may be passed through a hash algorithm to generate a 128 bit UUID associated with the context. One example of such a hashing algorithm is the FNV-1 hash function, which may generate 128 bit hash values based on input data of an arbitrary length. In some embodiments, the algorithm used to generate UUIDs may be easily inverted, such that a mobile device 102 with knowledge of the invertible algorithm is able to determine the initial context information used to generate a UUID. In other embodiments, the algorithm used to generate UUIDs may be a one-way algorithm, such that the information used to generate the UUIDs is not easily extracted from the UUID. Use of one-way algorithms may be beneficial, for example, to protect private information encoded within UUIDs. Where one-way algorithms are utilized to determine UUIDs, the mobile device 102 may not require knowledge of the underlying context information to enforce policy information. Rather, the mobile device 102 may directly correlate received UUIDs to enforceable policies. For example, the mobile device 102 may be configured to implement a specific policy when a corresponding UUID is received within service data, without being required to determine the context information from which the UUID was generated. Because such UUIDs represent context information usable by a mobile device 102 to implement context-dependent policies, such UUIDs can be considered to represent encoded context information, even where such encoded information is not directly decodable by the mobile device 102.

In some instances, UUIDs may be encrypted or altered in order to prevent unauthorized access. For example, a UUID may be generated based on an algorithm using as inputs current context information plus an arbitrary value known to the mobile device and the context assessment service (e.g., a “shared secret”), such that only a device with knowledge of the shared secret could discern the context. In another embodiment, a UUID may be encrypted in accordance with an asynchronous encryption schema, examples of which are well known within the art. For example, context information may be encrypted into a UUID with a public key of a mobile device, such that only the mobile device (having an associated private key) can decrypt the context. As yet another example, context information may be encoded into a UUID that is digitally signed with a private key, such that any receiving device can verify the source of the UUID (e.g., the context assessment service).

In one embodiment, the context assessment service 110 may generate a single UUID reflective of a determined context (e.g., a “driving” context). In another embodiment, the context assessment service 110 may generate multiple UUIDs reflective of multiple determined contexts (e.g., a “driving” context and an “in city” context). In yet another embodiment, the context assessment service 110 may generate UUIDs for specific sensor data determined from either the internal sensors 116 or the external sensors 120. For example, the context assessment service 110 may generate a UUID reflective of the specific speed at which a vehicle is traveling, or GPS coordinates of the location of the context assessment service 110.

After determining one or more UUIDs corresponding to current context information, the context assessment service 110 can generate service data reflective of the determined UUIDs. The service data can then be transmitted to the mobile deice 102, at (5), in response to the mobile devices 102 service query.

Traditionally, each UUID included within service data denotes a specific service available to a querying device, such as wireless headset services, wireless audio services, etc. In a similar manner, the context assessment service 110 may encode service data with the determined UUIDs reflect of current context information. Thus, devices within the context environment 125 who are unaware of the encoding used by the context assessment service 110 to generate the UUIDs may merely receive a listing of random UUIDs, interpretable as unknown services offered by the context assessment service 110. However, a mobile device 102 aware of the encoding used by the context assessment service 110 (e.g., by virtue of specialized policy enforcement software loaded within the mobile device 102) may be enabled to determine a current context from the received service data, and thus enforce policies based on received context information, without being required to maintain a dedicated connection to the context assessment service.

One interaction for enforcing policies based on encoded service data is described with respect to FIG. 2C. Specifically, the interactions of FIG. 2C continue those described above with respect to FIGS. 2A and 2B. Thus, the interactions of FIG. 2C begin at (6), where the mobile device 102 determines current context information based on the received service data. In one embodiment, the mobile device 102 may maintain (e.g., within the policy data store 108) a mapping of one or more UUIDs to specific contexts. Accordingly, the mobile device 102 may extract one or more UUIDs from received service data, and utilize the mapping to determine corresponding context information. In another embodiment, the mobile device 102 may be configured (e.g., via specialized software loaded onto the mobile device 102) with one or more algorithms to decode context information from UUIDs within received service data. For example, the mobile device 102 may be configured to invert an algorithm used by the context assessment service 110 to encode context data into UUIDs. As described above, context data may include one or more abstracted context identifiers (e.g., “driving,” “in city driving,” “highway driving,” “stationary,” etc.), specific sensor information (e.g., a speed of travel), a combination thereof, or other information enabling the mobile device 102 to implement context-dependent policies.

At (7), after determining specific context information, the mobile device 102 may utilize the context information to enforce policies on the mobile device 102. For example, a policy enforcement engine 106 within the mobile device 102 may utilize a determined context as well as one or more policies stored within the policy data store 108 to restrict or alter functionality of the mobile device 102. In one embodiment, the policy enforcement engine 106 may immediately implement any policies matching determined context information. For example, the policy enforcement engine 106 may modify a user interface to restrict functionality of the mobile device. Examples of systems and methods to modify user interfaces to restrict mobile device functionality are described, for example, within U.S. patent application Ser. No. 14/490,590, entitled “RESTRICTING FUNCTIONALITY OF PROTECTED DEVICES,” and filed Sep. 18, 2014, which is hereby incorporated by reference in its entirety. In other embodiments, the policy enforcement engine 106 may delay modifying functionality of the mobile device 102 until specific action is taken by the user, such as attempting to make a telephone call or send a text message. Thereafter, the policy enforcement engine 106 may take one or more actions to mitigate risk associated with the user action, as defined based on the determined context information and policies within the policy data store 108.

In some embodiments, policies within the policy data store 108 may be defined at least in part based on UUIDs themselves, rather than context information derived from UUIDs. For example, where a specific UUID corresponds to an “in motion” context, a policy may specify rules for restricting functionality of the mobile device 102 when the specific UUID is received within service data. In such embodiments, it may be unnecessary for the mobile device 102 to decode context information from received UUIDs. Accordingly, interaction (6) may be unnecessary, and therefore omitted. Further, while the interactions of FIGS. 2A-2C are described sequentially, some such interactions may occur simultaneously or in a different order than described above. For example, interactions (1′), (1″) and (2) (related to the use of sensor information to establish context) may occur in response to a service query by a mobile device 102, rather than prior to such a query. Further modifications to the interactions of FIGS. 2A-2C will be apparent to one skilled in the art in light of the present disclosure.

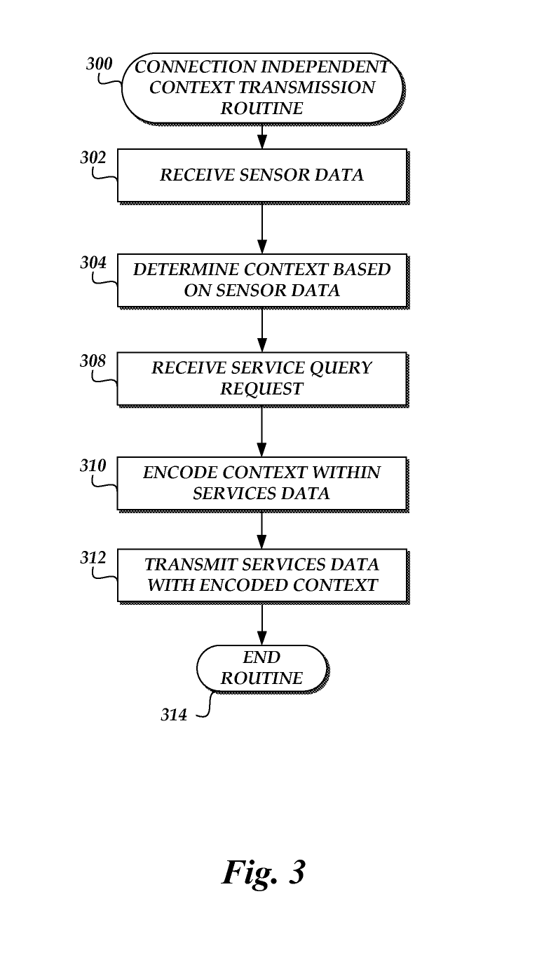

With reference to FIG. 3, one illustrative routine 300 for providing service data encoded with context information will be described. The routine 300 may be carried out, for example, by the context assessment service 110 of FIG. 1 to provide context information to a mobile device 102. Advantageously, the routine 300 may be executed by the context assessment service 110 independent of an established connection between the context assessment service 110 and the mobile device 110.

The routine 300 begins at block 302, where the context assessment service 110 receives sensor data related to a current context of the context assessment service 110 or a context environment 125 in which the context assessment service 110 operates. As described above, sensor data may include data generated internally by the context assessment service (e.g., via GPS systems, accelerometers, or antennae of the context assessment service 110), externally to the context assessment service (e.g., via sensors or monitoring systems within a vehicle associated with the context assessment service 110), or a combination thereof.

At block 304, the context assessment service 110 can determine current context information based on the sensor data. In one embodiment, current context information may include directly encoded sensor data, such as a speed of travel of the context environment 125. In another embodiment, current context information may include an abstracted context identifier determined based on sensor data (but not necessarily directly identifying the sensor data used to determine the context identifier). Illustratively, the context assessment service 110 may determine current context information based on one or more context rules maintained by the context assessment service 110. Such rules may specify, for example, a set of sensor data necessary or sufficient to establish the existence of a specific context.

In one embodiment, the context assessment service 110 may periodically refresh the determined context information based on newly available sensor data. For example, the context assessment service 110 may recheck available sensor data every n seconds to determine whether a new context has occurred. As a further example, the context assessment service 110 may be programmed with interrupts to enable detection of newly available sensor data at the context assessment service 110. Accordingly, while blocks 302 and 304 are described as preceding later blocks of the routine 300, blocks 302 and 304 may be implemented separately from the remaining portion of the routine 300 (e.g., within an infinitely looping subroutine).

After determining current context information, the routine 300 continues at block 308, where a service query is received from a mobile device 102. As described above, a service query may correspond to a request from a mobile device 102 to provide a listing of services made available by the context assessment service 110. For example, the service query may correspond to a BLUETOOTH SDP query, an SRV record query, an NFC LLCP query, or an IP Zeroconf query.

At block 310, the context assessment service 110 generates a set of service data to provide in response to the received query. Illustratively, the service data may include one or more UUIDs corresponding to determined context information. For example, the service data may include a UUID for each determined context identifier, exclusively or in addition to UUIDs reflective of specific sensor data detected by the context assessment service 110. In one embodiment, UUIDs are preconfigured to correspond to specific context identifiers or sensor data. In other embodiments, UUIDs can be generated at the context assessment service 110 by use of a specific algorithm, such as a hashing algorithm or encryption algorithm.

At block 312, the context assessment service 110 can respond to the service query with service data (e.g., a service record) including the determined UUIDs, after which the routine 300 may end at block 314. As described above, a receiving mobile device 102 may thereafter utilized the determined UUIDs (or context information derived from the UUIDs) to enforce context-based policies on the mobile device 102. Moreover, because the above-described service data enables transmission of context information within service discovery data, the mobile device 102 and the context assessment service 110 may not be required to “pair” or otherwise establish a connection in order to implement the routine 300.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Conjunctive language such as the phrase “at least one of X, Y, and Z” unless specifically stated otherwise, is otherwise understood with the context as used in general to convey that an item, term, etc. may be either X, Y, or Z, or a combination thereof. Thus, such conjunctive language is not generally intended to imply that certain embodiments require at least one of X, at least one of Y, and at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted or executed out of order from that shown or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A system for transmitting context information independent of an established communication channel, the system comprising:
one or more sensors configured to determine information regarding a mobile device environment; and
one or more processors configured with specific computer-executable instructions to:
obtain sensor data from the one or more sensors;
determine, based at least in part on the sensor data, context information of the mobile device environment;
receive, from a mobile device within the mobile device environment, a request for service data, wherein the request for service data is transmitted independent of an established connection between the one or more processors and the mobile device, and in accordance with a protocol enabling the service data to reflect services available to the mobile device;
encode within generated service data the determined context information; and
transmit, independent of an established connection between the one or more processors and the mobile device, the encoded service data to the mobile device as a response to the request for service data.

2. The system of claim 1, wherein the protocol corresponds to at least one of a BLUETOOTH, NFC LLCP, IP SLP, or IP Zeroconf protocol.

3. The system of claim 1, wherein the service data comprises one or more universally unique identifiers (UUIDs) corresponding to the context information.

4. The system of claim 1, wherein the one or more processors are further configured to generate the UUIDs.

5. The system of claim 1, wherein the context information comprises at least one of a context identifier abstracted from at least a portion of the sensor data.

6. A computer-implemented method comprising:
obtaining sensor data from the one or more sensors reflective of a mobile device environment;
determining, based at least in part on the sensor data, context information of the mobile device environment;
receiving, from a mobile device within the mobile device environment, a request for service data;
encoding within generated service data the determined context information; and
transmitting, independent of an established connection between the one or more processors and the mobile device, the encoded service data to the mobile device as a response to the request for service data.

7. The computer-implemented method of claim 6, wherein the service data comprises at least one of a BLUETOOTH SDP record, an NFC service record, or an IP SRV record.

8. The computer-implemented method of claim 6, wherein encoding the determined context information within the generated service data comprising generating one or more UUIDs based at least in part on the context information.

9. The computer-implemented method of claim 8, wherein the one or more UUIDs are based at least in part on at least one of a predetermined mapping of context information to UUIDs or an algorithm transforming the context information into the UUID.

10. The computer-implemented method of claim 6, wherein the context information is determined prior to receiving the request for service data.

11. A system for transmission of context information independent of an established communication channel, comprising:
a mobile device comprising one or more processors configured with specific computer-executable instructions to:
transmit a request for service data to an external device, wherein the request for service data is transmitted independent of an established connection between the external device and the mobile device;
receive the service data from the mobile device;
analyze the service data to determine current context information of the mobile device; and
modify functionality of the mobile device based at least in part on the context information encoded within the service data.

12. The system of claim 11, wherein the mobile device is configured to determine the current context information based at least in part on decoding context information within the service data.

13. The system of claim 12, wherein decoding context information within the service data comprises extracting one or more UUIDs from the service data.

14. The system of claim 13, wherein decoding context information within the service data comprises at least one of comparing the extracted one or more UUIDs to a data mapping of the one or more UUIDs to corresponding context information or processing the one or more UUIDs according to a predefined algorithm to transform the one or more UUIDs into context information.

15. A computer-implemented method comprising:
transmitting from a mobile device, a request for service data, wherein the request for service data is transmitted independent of an established connection between the mobile device and an external device to which the request is transmitted;
receiving the service data from the mobile device;
analyzing the service data to determine context information encoded within the service data; and
modifying functionality of the mobile device based at least in part on the context information encoded within the service data.

16. The computer-implemented method of claim 15, wherein analyzing the service data comprises decrypting the service data.

17. The computer-implemented method of claim 16, wherein the service data is encrypted according to at least one of asymmetrical or symmetrical encryption.

18. The computer-implemented method of claim 15, wherein modifying functionality of the mobile device based at least in part on the context information encoded within the service data comprises:
receiving one or more context-based policies;
determining at least one policy of the one or more context-based policies corresponding to the determined context information; and
modifying functionality of the mobile device in accordance with the determined at least one policy.

19. The computer-implemented method of claim 15, wherein the request for service data is a broadcast request.

20. The computer-implemented method of claim 15, wherein the mobile device is configured to repeatedly transmit requests for service data at a specified interval.
